(19) United States
(12) Patent Application Publication
(10) Pub. No.: US 2016/0219209 A1
(43) Pub. Date: Jul. 28, 2016

(54) TEMPORAL MEDIAN FILTERING TO REMOVE SHADOW

(71) Applicants: Aashish KUMAR, Bangalore (IN); Kadagattur Gopinatha SRINIDHI, Bangalore (IN); Hewlett-Packard Development Company, L.P., Houston, TX (US)

(72) Inventors: Aashish Kumar, Bangalore (IN); Kadadattur Gopinatha Srinidhi, Bangalore (IN)

(21) Appl. No.: 14/914,508

(22) PCT Filed: Aug. 26, 2013
(86) PCT No.: PCT/IN2013/000516

§ 371 Date: Feb. 25, 2016

(51) Int. Cl. H04N 5/235; G06T 5/20; H04N 1/40

(52) U.S. Cl. CPC H04N 5/2356; H04N 1/40012; G06T 5/20; G06T 2207/20032; G06T 2207/20182

(57) ABSTRACT

A method is described of image processing in which three input images are filtered to generate a temporal median filtered image, each of the three input images representing a same scene and captured under different lighting conditions relative to each other. A shadow present in one or more of the three input images is identified and removed from the temporal median filtered image to generate an output image.

### BACKGROUND

Image capture devices have become increasingly common. For example, devices such as smartphones, laptops, desktops, scanners, digital cameras, video cameras, charge-coupled device (CCD) cameras, and other devices may operate as image capture devices. Such image capture devices may be used with flash illumination, and/or in conditions in which there may be various ambient light sources.

### BRIEF DESCRIPTION OF THE DRAWINGS

Some examples are described with respect to the following figures:

FIG. 1 is a flow diagram illustrating a method of image processing according to some examples;

FIG. 2 is a simplified illustration of a computing system according to some examples;

FIG. 3 is a simplified illustration of a computing system according to some examples;

FIG. 4 is a flow diagram illustrating a method of a method of image processing according to some examples.

FIGS. 5-7 are input images according to some examples;

FIG. 8 is a background image according to some examples;

FIG. 9 is a temporal median filtered image according to some examples;

FIG. 10 is a composite dark image according to some examples;

FIG. 11 is a composite bright image according to some examples;

FIGS. 13-17 are difference images according to some examples;

FIG. 18 is a region grown difference image according to some examples; and

FIG. 19 is an output image according to some examples.

### DETAILED DESCRIPTION

Before particular examples of the present disclosure are disclosed and described, it is to be understood that this disclosure is not limited to the particular examples disclosed herein as such may vary to some degree. It is also to be understood that the terminology used herein is used for the purpose of describing particular examples only and is not intended to be limiting, as the scope of the present disclosure will be defined only by the appended claims and equivalents thereof.

Notwithstanding the foregoing, the following terminology is understood to mean the following when recited by the specification or the claims. The singular forms ‘a,’ ‘an,’ and ‘the’ are intended to mean ‘one or more.’ For example, ‘a part’ includes reference to one or more of such a ‘part.’ Further, the terms ‘including’ and ‘having’ are intended to have the same meaning as the term ‘comprising’ has in patent law. The terms ‘substantially’ and ‘about’ mean a ±10% variance.

Some captured images may be affected by shadows and glares, for example due to light sources including camera flashes and natural and artificial ambient light sources. For example, camera flashes near an image capture device, or undesired placement or light intensities of concentrated ambient light sources, may cause shadows and glares in captured images.

Accordingly, the present disclosure concerns imaging systems, computer readable storage media, and methods of image processing. For example, image data present in three input images of the same scene, each captured with flashes at different locations, may be used to generate a single output image with reduced shadow and glare.

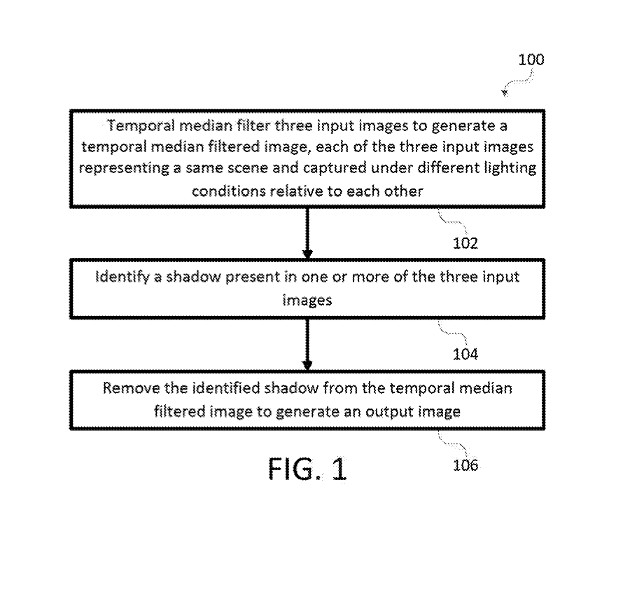

FIG. 1 is a flow diagram illustrating a method 100 of image processing according to some examples. At block 102, three input images may be temporal median filtered to generate a temporal median filtered image. Each of the three input images may represent a same scene and captured under different lighting conditions relative to each other. The temporal median filtering serves to reduce shadow and significantly reduce glare in the image relative to any of the three input images. As defined herein, inclusion of the term “temporal” in “temporal median filter” means that the temporal median filter determines a median pixel value of corresponding pixels of different images captured at different times. Normally, the input images may be captured in close succession as in a burst lasting less than a second, but this need not be the case. For example, the input images may in some examples be captured with longer periods of time between captures, and/or may be captured with unequal times between captures. Use of temporal median filtering has been found to reduce glare in the images to a generally acceptable level. This is based on the assumption that, due to typical textures and materials of objects represented in captured input images and due to lighting conditions generated by light sources during capture, glare generally does not occur at the same location in two of three input images. However, this is not the case for shadow. A portion of shadow may commonly occur in the same location in two of the three input images. In consequence at block 104, a shadow present in one or more of the three input images may be identified. At block 106, the identified shadow may be removed from the temporal median filtered image to generate an output image.

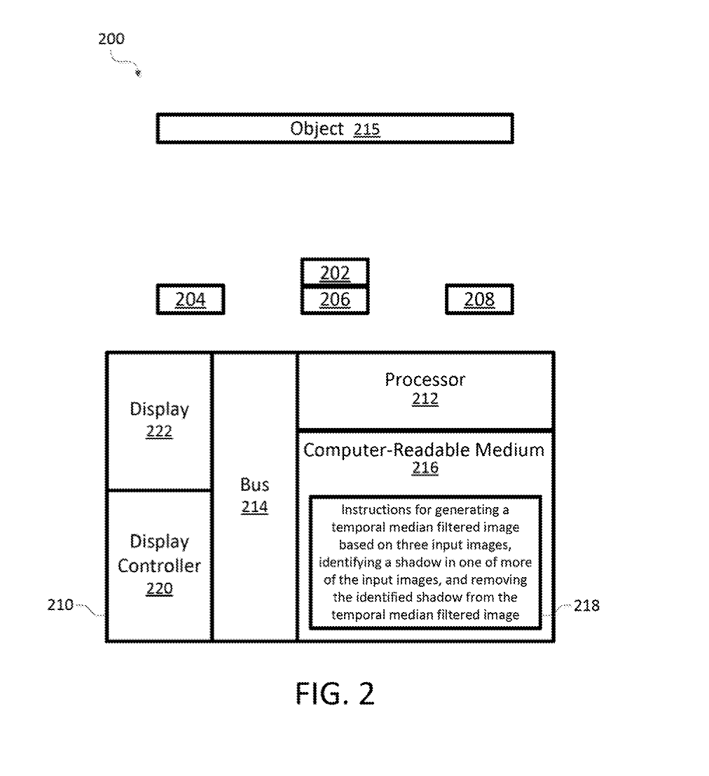

FIG. 2 is a simplified illustration of an imaging system 200 according to some examples. Any of the operations and methods disclosed herein may be implemented and controlled in the imaging system 200. The imaging system 200 may include an image capture device 202. The image capture device 202 may be part of a smartphone, laptop, desktop, scanner, digital camera, video camera, charge-coupled device (CCD) camera, or the like. The imaging system 200 may include three light sources 204, 206, and 208, such as flash units. The flash units may include light-emitting diodes (LEDs). The methods described herein may be robustly operable with any spatial configuration of the light sources 204, 206, and 208. For example, the three light sources 204, 206, and 208 may be spaced apart from each other. As shown in FIG. 2, relative to the image capture device 202, the light source 204 may, for example, be placed to the left, the light source 206 may be placed in the center, and the light source 208 may be placed to the right. In some examples, the light sources 204, 206, and 208 may be part of and may be located at different locations on the image capture device 202. A substrate or object 215, such as a paper sheet or a three-dimensional object, may be placed several centimeters away, such as about 10 to about 50 centimeters away. In examples in which the image capture device 202 may be a camera such as a digital camera or the like, the light sources 204, and 206, 208 may be flash units located at different locations on the camera, or they may be separate flash units attached to lighting stands, for example.

Any of the operations and methods disclosed herein may be implemented and controlled in one or more computing systems. For example, the imaging system 200 may include a computer system 210, which may, for example, be integrated in or may be external to the image capture device 202, for instance in examples where the computer system 200 and image capture device 202 form part of a smartphone, laptop, desktop, scanner, digital camera, video camera, or charge-coupled device (CCD) camera.

The computer system 210 may include a processor 212 for executing instructions such as those described in the methods herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The computer system 210 may include a display controller 220 responsive to instructions to generate a textual display, or a graphical display such as any of the input images, output images, or intermediate images generated in the methods disclosed herein, on a display device 222 such as a computer monitor, camera display, or the like.

The processor 212 may be in communication with a computer-readable medium 216 via a communication bus 214. The computer-readable medium 216 may include a single medium or multiple media. For example, the computer readable medium may include one or both of a memory of the ASIC, and a separate memory in the computer system 210. The computer readable medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable medium 216 may be non-transitory. The computer-readable medium 216 may store, encode, or carry computer executable instructions 218 that, when executed by the controller 210, processor 212 or a suitable processing system, may cause the controller 210, processor 212, or the suitable processing system to perform any one or more of the methods or operations disclosed herein according to various examples.

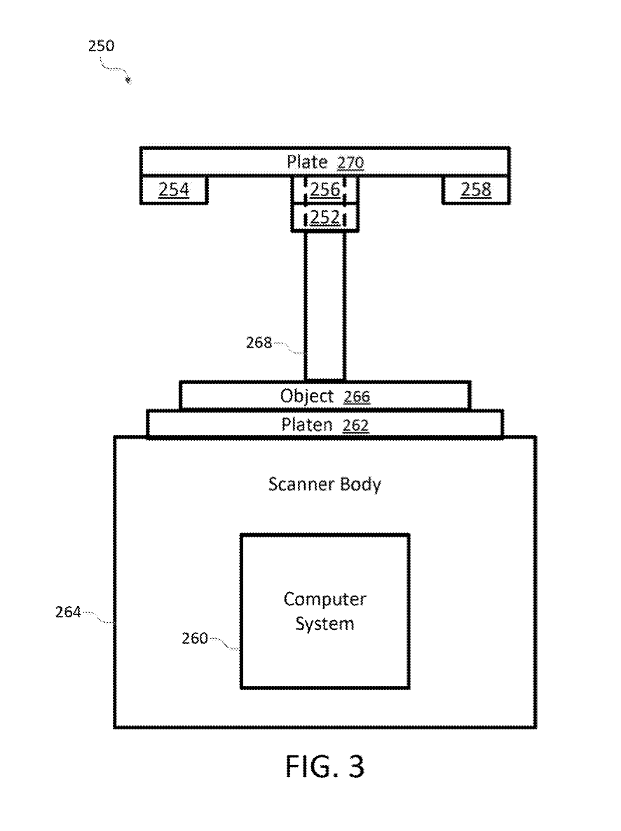

FIG. 3 is a simplified illustration of an imaging system 250 according to some examples. The imaging system 250 may be a scanner, and may include an image capture device 252 such as the image capture device 202, three light sources 254, 256, and 258 such as the light sources 204, 206, and 208, a computer system 260 such as the computer system 210, a platen 262, and a scanner body 264. An object 266 to be scanned may be placed on the platen 262. A mounting shaft 268 may extend from the scanner body 264 to a plate 270. The image capture device 252 and the light sources 254, 256, and 258 may be attached to the plate 270 such that they may be placed in an overhead arrangement facing an object 266 to be scanned from a distance of several centimeters away, such as about 10 to about 50 centimeters. The image capture device 252 may be attached to the center of the plate 270. Relative to the image capture device 252, the light source 254 may, for example, be placed to the left, the light source 256 may be placed in the center, and the light source 258 may be placed to the right. The computer system 210 may be part of the scanner, as shown in FIG. 3, or may be external to the scanner.

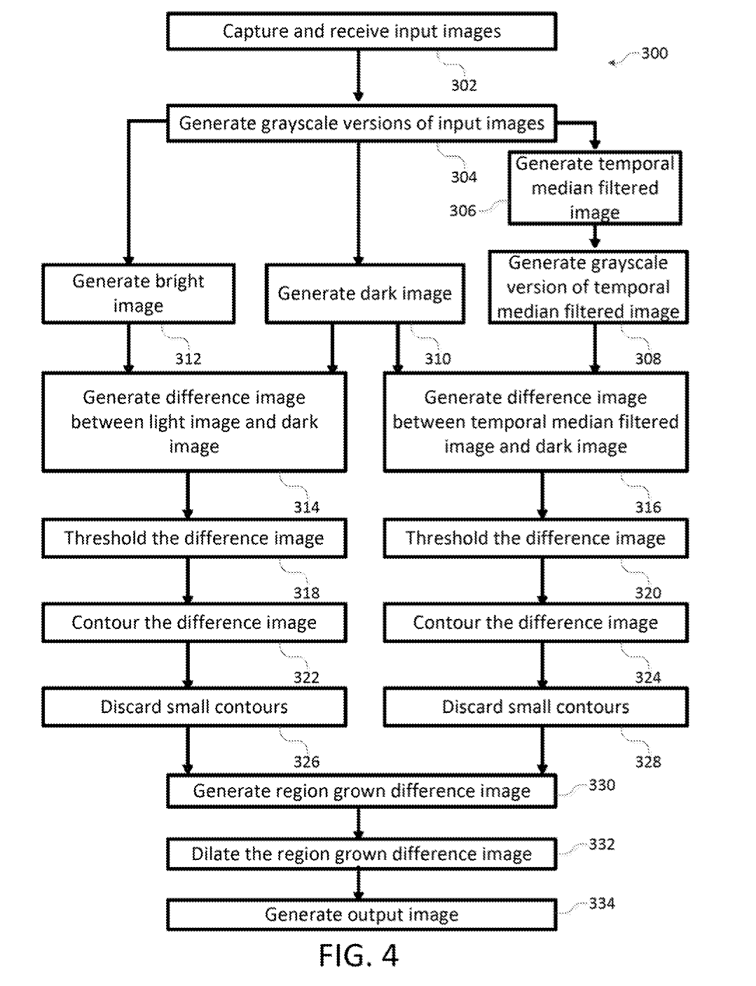

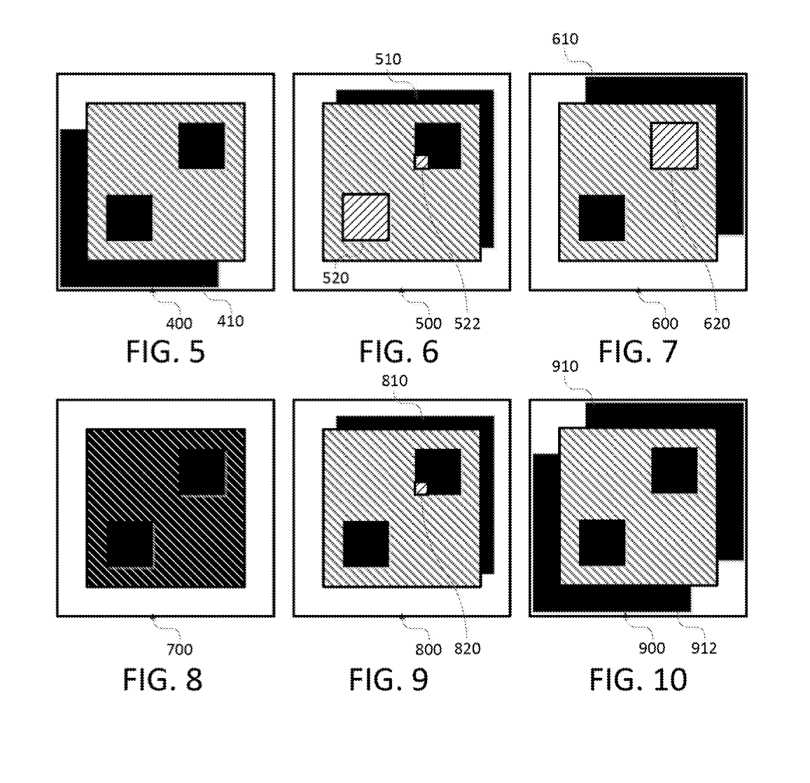

FIG. 4 is a flow diagram illustrating a method 300 of image processing according to some examples. In describing FIG. 4, reference to FIGS. 5-17 will be made. In some examples, the ordering shown may be varied, such that some steps may occur simultaneously, some steps may be added, and some steps may be omitted such as steps 302, 304, 308, and 314-328.

At block 302, three input images 400, 500, and 600 may be captured by the image capture device 202, as shown in FIGS. 5-7. Each of the three input images 400, 500, and 600 may represent the same scene, and may be each captured under different lighting conditions relative to each other. For example, the three input images 400, 500, and 600 may be captured successively, for example in a burst. During capture of each of the three input images 400, 500, 600, a respective one of three light sources 204, 206, and 208 may be lighted, while the other two may not be lighted. For example, light source 204 may be lighted while capturing image 400, light source 206 may be lighted while capturing image 500, and light source 208 may be lighted while capturing image 600. In examples in which the light sources 204, 206, and 208 are spaced in a left-center-right pattern, as described earlier, the input image 400, 500, and 600 may respectively be left, center, and right input images corresponding to which light source 204, 206, and 208 was lighted during respective capture. The input images 400, 500, and 600 may include shadows 410, 510, and 610 and glares 520, 522, and 620.

In some examples in which the image capture device 202 is movable relative to the light sources 204, 206, and 208, such as when the image capture device 202 is a mobile device such as a camera and the light sources 204, 206, and 208 are separate flash units attached to lighting stands, the captured input images 400, 500 and 600 may capture an object but at different angles. For example, a user may change locations to capture the object at different angles. In these examples, the captured input images 400, 500 and 600 may be processed such that they appear to have been taken from the same angle, thus representing the same identical scene.

In some examples, a background image 700 may additionally be captured by the image capture device 202, and may be part of the burst, as shown in FIG. 8. The background image 700 may represent the same scene as the three input images 400, 500, and 600, but none of the light sources 204, 206, and 208 may be lighted during capture of the background image 700. Thus, the background image 700 may be darker than the input images 400, 500, and 600, as shown in FIG. 8.

The input images 400, 500, and 600, and the background image 700, may be received by the computer system 200 and stored in the computer-readable medium 216. The input images 400, 500, and 600, and the background image 700, may be stored in any suitable format, such as raster formats. Example formats include JPEG, GIF, TIFF, RAW, PNG, BMP, PPM, PGM, PBM, XBM, ILBM, WBMP, PNM, CGM, and SVG. In some examples, each input image 400, 500, and 600, and the background image 700, may be represented by a grid of pixels, for example at a resolution of 8 megapixels. In some examples, each pixel may be represented by any number of bits, for example 8 bits enabling 256 colors, 16 bits enabling 65,536 colors, or 24 bits enabling 16,777,216 colors. The images may, for example, be grayscale images, or may be color images having R, G, and B components. For example, for an 8 bit grayscale image, the minimum value of 0 may represent black and the maximum value of 255 may represent white. For a 24 bit color image such as the true color format, R, G, and B each may be represented by 8 bits and each may have minimum values of 0 and maximum values of 255.

The background image 700, if taken, may be used to determine how much illumination may be present in the input images 400, 500, and 600, and then to modify the captured input images 400, 500, and 600 to have a substantially similar degree of illumination.

In some examples, the captured input images 400, 500, and 600 may be cropped such that they include only an intended object to be captured, for example when object is placed on the platen 262 of a scanner, and the object is not large enough to cover a scannable area on the platen, thus leaving an empty area at the margins of the scannable area.

At block 304, if the three input images 400, 500, and 600 are not in grayscale, then grayscale versions of the input images 400, 500, and 600 may be generated. For example, if the three input images 400, 500, and 600 are in an 8 bit RGB format or in a 24 bit RGB format, then the grayscale versions may be generated in 8 bit grayscale format. In some examples, for a given pixel, only the R bits (red channel only), only the G bits (green channel only), or only the B bits (blue channel only) may be used for conversion to the grayscale bits for that pixel. In other examples, the grayscale bit for the pixel may be generated based on two or three of the R, G, and B bits for the pixel. In examples in which the three input images 400, 500, and 600 are already in grayscale, then references to grayscale versions in the following steps is understood to be equivalent to reference to the input images 400, 500, and 600.

At block 306, a shadow and/or glare reduced temporal median filtered image 800 may be generated based on the three input images 400, 500, and 600 and their grayscale versions, as shown in FIG. 9. As will be described in more detail below, shadow may be partially removed in the temporal median filtered image 800, and glare may be substantially removed such that there may be a sufficiently low amount of glare in the output image 1400. This may occur because any feature found in at least two of the three input images 400, 500, and 600 may be included in the determined temporal median filtered image 800, and any feature found in only one of the three input images 400, 500, and 600 may not be included in the determined temporal median filtered image 800.

In the examples of FIGS. 5-7, because of textures and materials of objects represented in captured input images 400, 500, and 600, the geometric arrangement of the light sources 204, 206 and 208, and the optical properties of the light produced by the light sources 204, 206 and 208, some portions of shadows 510 and 610 overlap in the same location two of the input images 400, 500 and 600, and glares 520, 522 and 620 substantially do not overlap in the same location in more than one input image 400, 500 or 600 except for a small amount of glare 522 which overlaps glare 620. Thus, the shadows 510 and 610 are only partially removed, but the glares 520 and 620 are removed or substantially removed except for a small amount of glares 522 and 620 which overlap in the same location and are thus not removed.

To complete shadow removal from the temporal median filtered image 800, (1) at blocks 308 to 332, all or substantially all of the shadows of the input images 400, 500, and 600, and their full sizes, may be identified, and (2) at block 334, the identified shadows may be removed from the temporal median filtered image 800 to generate the output image 1400 which may have minimized shadow and minimized glare.

Turning back to block 306 to describe operation of the temporal median filter, each pixel value at an x and a y coordinate of the temporal median filtered image 800 (I_{F}) may be determined by: (1) selecting a median pixel value of three corresponding pixel values of the grayscale versions (G₁, G₂, G₃) of the input images 400 (I₁), 500 (I₂), 600 (I₃) having the same x and y coordinate; and (2) assigning, to the pixel value of the temporal median filtered image 800 (I_{F}), a pixel value of the one of the three input images 400 (I₁), 500 (I₂), and 600 (I₃) for which the corresponding median pixel value of the one of the three grayscale versions (G₁, G₂, G₃) may have been selected in step (1). The determination may, for example, be implemented according to the following:

$${I}_{F} ( x , y ) = \{ \begin{matrix}{I}_{1} ( x , y ) if {G}_{1} ( x , y ) = median of set \{ {G}_{1} ( x , y ) , {G}_{2} ( x , y ) , {G}_{3} ( x , y ) \} \\ {I}_{2} ( x , y ) if {G}_{2} ( x , y ) = median of set \{ {G}_{1} ( x , y ) , {G}_{2} ( x , y ) , {G}_{3} ( x , y ) \} \\ {I}_{3} ( x , y ) if {G}_{3} ( x , y ) = median of set \{ {G}_{1} ( x , y ) , {G}_{2} ( x , y ) , {G}_{3} ( x , y ) \}\end{matrix}$$

At block 308, in examples in which the input images 400, 500, and 600 are not in grayscale, a grayscale version of the the temporal median filtered image 800 may be generated. For example, if the temporal median filtered image 800 is in an 8 bit RGB format or in a 24 bit RGB format, then the grayscale version may be generated in 8 bit grayscale format. In some examples, for a given pixel, only the R bits (red channel only), only the G bits (green channel only), or only the B bits (blue channel only) may be used for conversion to the grayscale bits for that pixel. In other examples, the grayscale bit for the pixel may be generated based on two or three of the R, G, and B bits for the pixel. In examples in which the temporal median filtered image 800 is already in grayscale, then references to a grayscale version of the temporal median filtered image in the following steps is understood to be equivalent to reference to the temporal median filtered image 800.

At block 310, a composite dark image 900 of the input images 400, 500, and 600 may be generated, as shown in FIG. 10. In examples in which the grayscale versions (G₁, G₂, G₃) of the input images 400 (I₁), 500 (I₂), 600 (I₃) are each 8-bit grayscale images having pixel values ranging from a minimum of 0 representing black to a maximum of 255 representing white, each pixel at an x and a y coordinate of the composite dark image 900 may be determined by assigning, to the pixel value of the composite dark image 900 (I_{D}), a smallest pixel value of three corresponding pixel values of the grayscale versions (G₁, G₂, G₃) of the input images 400 (I₁), 500 (I₂), 600 (I₃) having the same x and y coordinate. The determination may, for example, be implemented according to the following:

$${I}_{D} ( x , y ) = \{ \begin{matrix}{G}_{1} ( x , y ) if {G}_{1} ( x , y ) = smallest of set \{ {G}_{1} ( x , y ) , {G}_{2} ( x , y ) , {G}_{3} ( x , y ) \} \\ {G}_{2} ( x , y ) if {G}_{2} ( x , y ) = smallest of set \{ {G}_{1} ( x , y ) , {G}_{2} ( x , y ) , {G}_{3} ( x , y ) \} \\ {G}_{3} ( x , y ) if {G}_{3} ( x , y ) = smallest of set \{ {G}_{1} ( x , y ) , {G}_{2} ( x , y ) , {G}_{3} ( x , y ) \}\end{matrix}$$

In examples in which the white is represented by a minimum value such as 0 and black is represented by a maximum value such as 255, the same process above may be followed, except that a largest, rather than smallest, pixel value of the three corresponding pixel values of the grayscale versions (G₁, G₂, G₃) may be selected. Thus, in either case, the darkest pixel value may be selected.

Because the smallest pixel values may be selected, the determined composite dark image 900 may remove and thus may not include glares, but may not remove and thus may include shadows 910 and 912 of the grayscale versions (G₁, G₂, G₃) of the input images 400 (I₁), 500 (I₂), 600 (I₃).

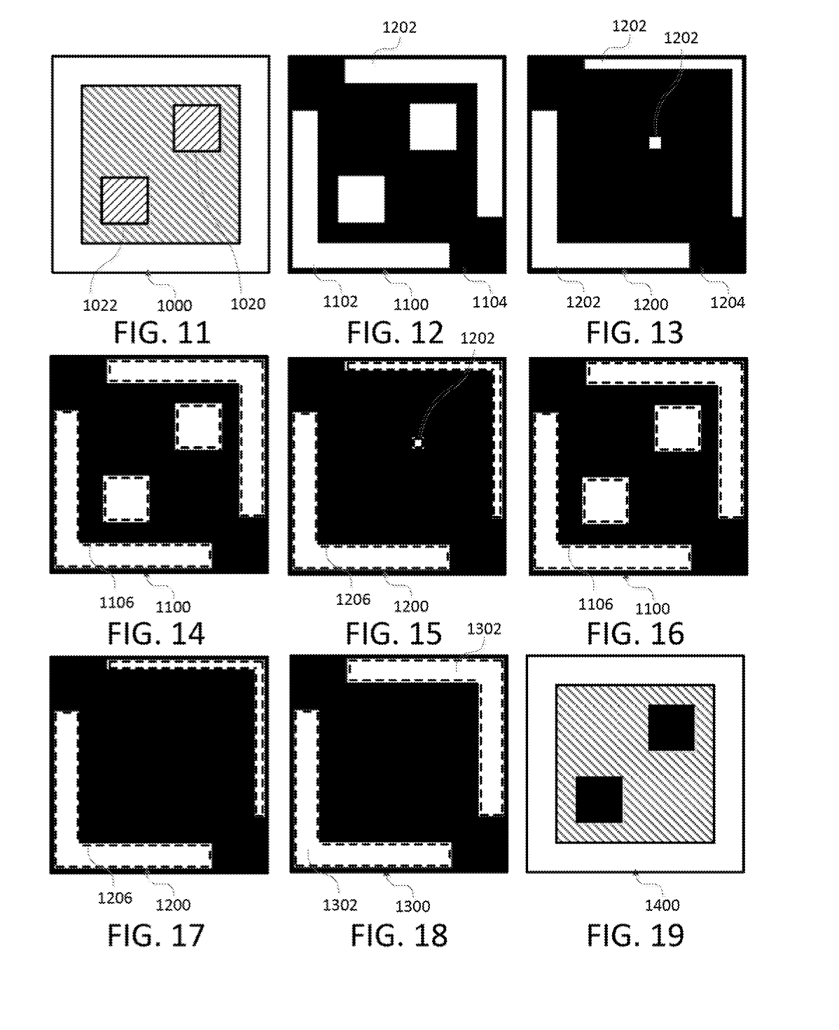

At block 312, a composite bright image 1000 of the input images 400, 500, and 600 may be generated, as shown in FIG. 11. In examples in which the grayscale versions (G₁, G₂, G₃) of the input images 400 (I₁), 500 (I₂), 600 (I₃) are each 8-bit grayscale images having pixel values ranging from a minimum of 0 representing black to a maximum of 255 representing white, each pixel at an x and a y coordinate of the composite bright image 1000 may be determined by assigning, to the pixel value of the composite bright image 1000 (I_{L}), a largest pixel value of three corresponding pixel values of the grayscale versions (G₁, G₂, G₃) of the input images 400 (I₁), 500 (I₂), 600 (I₃) having the same x and y coordinate. The determination may, for example, be implemented according to the following:

$${I}_{L} ( x , y ) = \{ \begin{matrix}{G}_{1} ( x , y ) if {G}_{1} ( x , y ) = largest of set \{ {G}_{1} ( x , y ) , {G}_{2} ( x , y ) , {G}_{3} ( x , y ) \} \\ {G}_{2} ( x , y ) if {G}_{2} ( x , y ) = largest of set \{ {G}_{1} ( x , y ) , {G}_{2} ( x , y ) , {G}_{3} ( x , y ) \} \\ {G}_{3} ( x , y ) if {G}_{3} ( x , y ) = largest of set \{ {G}_{1} ( x , y ) , {G}_{2} ( x , y ) , {G}_{3} ( x , y ) \}\end{matrix}$$

In examples in which the white is represented by a minimum value such as 0 and black is represented by a maximum value such as 255, the same process above may be followed, except that a smallest, rather than largest, pixel value of the three corresponding pixel values of the grayscale versions (G₁, G₂, G₃) may be selected. Thus, in either case, the brightest pixel value may be selected.

Because the largest pixel values may be selected, the determined composite bright image 1000 may remove and thus may not include shadows, but may not remove and thus may include glares 1020 and 1022 of the grayscale versions (G₁, G₂, G₃) of the input images 400 (I₁), 500 (I₂), 600 (I₃).

At block 314, as shown in FIG. 12, a difference image 1100 may be generated based on the composite dark image 900 and the composite bright image 1000 by, for example, assigning, to each pixel value at an x and a y coordinate of the difference image 1100, a value representing the difference between a corresponding pixel value of the composite dark image 900 having the same x and y coordinate from a corresponding pixel value of the composite bright image 1000 having the same x and y coordinate. The difference image 1100 is shown in FIG. 12 after the thresholding of step 318.

At block 316, as shown in FIG. 13, a difference image 1200 may be generated based on the temporal median filtered image 800 and the composite dark image 900 by, for example, assigning, to each pixel value at an x and a y coordinate of an intermediate difference image, a value representing the difference between a corresponding pixel value of the temporal median filtered image 800 having the same x and y coordinate from a corresponding pixel value of the composite dark image 900 having the same x and y coordinate. The difference image 1200 is shown in FIG. 13 after the thresholding of step 320.

At block 318, in some examples, the difference image 1100 may be thresholded, such that it may become, for example, a binary mask image in which highlighted regions 1102 may, for example, have pixel values of 255, and non-highlighted regions 1104 may, for example, have pixel values of 0. As discussed earlier, the composite dark image 900 may include no glares but may include all or substantially all of the shadows of the input images 400, 500, and 600, and the composite dark image 900 may include no shadows but all or substantially all of the glare of the input images 400, 500, and 600. Thus, the highlighted regions 1102 may represent glare and shadow of the input images 400, 500, and 600, and the non-highlighted regions 1104 may represent regions of the input images 400, 500, and 600 not having glare and shadow.

At block 320, in some examples, the difference image 1200 may be thresholded, such that it may become, for example, a binary mask image in which highlighted regions 1202 may, for example, have pixel values of 255, and non-highlighted regions 1202 may, for example, have pixel values of 0. As discussed earlier, the temporal median filtered region 800 may include no glare but may include some shadows of the input images 400, 500, and 600, and the composite dark image 900 may include no glare but all or substantially all of the shadows of the input images 400, 500, and 600. Thus, the highlighted regions 1202 may represent shadows of the input images 400, 500, and 600 that may have been removed from and thus not included in the temporal median filtered image 900. In some examples, the highlighted regions 1104 may include a small amount of glare as shown in the center of FIG. 13, but in other examples, they may include no glare.

At blocks 322 and 324 respectively, contour processing may be performed on the respective difference images 1100 and 1200, such that they may become contoured images, in some examples. For example, for each highlighted region 1102 and 1202, a contour 1106 or 1206 may be generated which may represent an outline of the contoured region, as shown in FIGS. 14 and 15.

At blocks 326 and 328 respectively, small contours may be discarded, because they may be present due to noise, or due to small glares such as the small glare 1202 in the center of FIG. 15. For example, small glares may be present in the temporal median filtered image 800 that may not have been fully removed by way of temporal median filtering, and thus may be present in the difference image 1200 prior to discarding. FIGS. 16 and 17 illustrate the difference images 1100 and 1200 with small contours discarded.

At block 330, in some examples, additional contour processing may be performed to generate a region grown difference image 1300 based on the difference images 1100 and 1200, as shown in FIG. 18. For example, the contours of the difference image 1200 may be region grown onto the contours of the contoured image 1100 to generate the contoured region 1302. In some examples, the region growing may be permitted only up to a threshold size, which may be determined and revised heuristically through repeated current and/or past applications of the method 300. The region growing may not capture any contoured glare region of the difference image 1100, because the contoured glare regions may not overlap any contoured shadow regions. Thus, the generated region grown image 1300 may include contours that represent and surround all or substantially all of the shadow regions from the input images 400, 500, and 600, but may not include contours that represent glares.

At block 332, in some examples, the region grown difference image 1300 may be dilated by a mask to compensate for edge effects that may be caused by binarization. To preserve high image quality, the size of the mask may be selected based on the resolution, such as dots-per-inch, of the region grown difference image 1300, and based on the quality of the initial image captures. In some examples, the mask may have a size of 5×5 pixels. Thus, the contoured regions 1302 may be expanded in size. The contoured regions 1302 may identify the shadows such as all or substantially of the shadows of the input images 400, 500, and 600.

At block 334, an output image 1400 shown in FIG. 19 may be generated based on the temporal median filtered image 800, composite bright image 1000, and region grown difference image 1300. For example, for regions having x and y coordinates outside the contoured regions 1302 of the region grown difference image 1300, the output image 1400 may include pixels from corresponding regions of the temporal median filtered image 800 having x and y coordinates. For regions having x and y coordinates inside the contoured regions 1302 of the region grown difference image 1300, the output image 1400 may include pixels from corresponding regions of the composite bright image 1000 having x and y coordinates.

Thus, the output image 1400 may be a color image in the original format of the input images 400, 500, and 600 and may show the full scene shown the input images 400, 500, and 600. However, the output image 1400 may include no or substantially no shadows that may be present in the input images 400, 500, and 600. Thus, the identified shadow from the region grown difference image 330 may be removed from the temporal median filtered image 800 to generate the output image 1400. Additionally, the output image 1400 may include reduced glares, such as no or substantially no glares, relative to the input images 400, 500, and 600. In some examples, the method 300 may be designed such that a small amount of glare may remain in the output image 1400, because full glare removal may result in a dull image.

In some examples, the method 300 may process color versions of the images rather than grayscale versions. For example, although the method 300 shown in FIG. 4 includes generating, in steps 304 and 308, grayscale versions of the temporal median filtered image 800 and input images 400, 500, and 600, steps 304 and 308 may be omitted. Thus, for example, the steps of the method 300, such as steps 306, 310, and 312 as described in more detail below, may be suitably modified such that the steps may be performed on color versions of the input images 400, 500, and 600. The following examples may be implemented for a 24 bit color input images 400, 500, and 600.

Initially, for blocks 306, 310, and 312, for each pixel of the input images 400 (I₁), 500 (I₂), and 600 (I₃) having the same x and y coordinate, a lightness pixel value may be determined by adding together the R, G, and B pixel values, each of which may be represented by 8 buts and thus may be valued from 0 to 255. The lightness pixel values may be determined according to the following:

I_{1A}(x,y)=I_{1R}(x,y)+I_{1G}(x,y)+I_{1B}(x,y),

I_{2A}(x,y)=I_{2R}(x,y)+I_{2G}(x,y)+I_{2B}(x,y),

I_{3A}(x,y)=I_{3R}(x,y)+I_{3G}(x,y)+I_{3B}(x,y).

At block 306, each pixel value at an x and a y coordinate of the temporal median filtered image 800 (I_{F}) may be assigned with a median pixel value selected from among the three corresponding determined lightness pixel values of the input images 400 (I₁), 500 (I₂), 600 (I₃) having the same x and y coordinate of the temporal median filtered image 800 (I_{F}) being determined. The determination may, for example, be implemented according to the following:

$${I}_{F} ( x , y ) = \{ \begin{matrix}{I}_{1} ( x , y ) if {I}_{1 A} ( x , y ) = median of set \{ {I}_{1 A} ( x , y ) , {I}_{2 A} ( x , y ) , {I}_{3 A} ( x , y ) \} \\ {I}_{2} ( x , y ) if {I}_{2 A} ( x , y ) = median of set \{ {I}_{1 A} ( x , y ) , {I}_{2 A} ( x , y ) , {I}_{3 A} ( x , y ) \} \\ {I}_{3} ( x , y ) if {I}_{3 A} ( x , y ) = median of set \{ {I}_{1 A} ( x , y ) , {I}_{2 A} ( x , y ) , {I}_{3 A} ( x , y ) \}\end{matrix}$$

At block 310, each pixel value at an x and a y coordinate of the composite dark image 900 may be assigned with a smallest pixel value of three corresponding determined lightness values of the input images 400 (I₁), 500 (I₂), 600 (I₃) having the same x and y coordinate. The determination may, for example, be implemented according to the following:

$${I}_{F} ( x , y ) = \{ \begin{matrix}{I}_{1} ( x , y ) if {I}_{1 A} ( x , y ) = smallest of set \{ {I}_{1 A} ( x , y ) , {I}_{2 A} ( x , y ) , {I}_{3 A} ( x , y ) \} \\ {I}_{2} ( x , y ) if {I}_{2 A} ( x , y ) = smallest of set \{ {I}_{1 A} ( x , y ) , {I}_{2 A} ( x , y ) , {I}_{3 A} ( x , y ) \} \\ {I}_{3} ( x , y ) if {I}_{3 A} ( x , y ) = smallest of set \{ {I}_{1 A} ( x , y ) , {I}_{2 A} ( x , y ) , {I}_{3 A} ( x , y ) \}\end{matrix}$$

In examples in which the brightest value of the lightness pixel value is represented by a minimum value and the darkest value of the lightness pixel value is represented by a maximum value, the same process above may be followed, except that a largest, rather than smallest, pixel value of the three corresponding determined lightness values may be selected.

At block 312, each pixel value at an x and a y coordinate of the composite bright image 1000 may be assigned with a largest pixel value of three corresponding determined lightness values of the input images 400 (I₁), 500 (I₂), 600 (I₃) having the same x and y coordinate. The determination may, for example, be implemented according to the following:

$${I}_{F} ( x , y ) = \{ \begin{matrix}{I}_{1} ( x , y ) if {I}_{1 A} ( x , y ) = largest of set \{ {I}_{1 A} ( x , y ) , {I}_{2 A} ( x , y ) , {I}_{3 A} ( x , y ) \} \\ {I}_{2} ( x , y ) if {I}_{2 A} ( x , y ) = largest of set \{ {I}_{1 A} ( x , y ) , {I}_{2 A} ( x , y ) , {I}_{3 A} ( x , y ) \} \\ {I}_{3} ( x , y ) if {I}_{3 A} ( x , y ) = largest of set \{ {I}_{1 A} ( x , y ) , {I}_{2 A} ( x , y ) , {I}_{3 A} ( x , y ) \}\end{matrix}$$

In examples in which the brightest value of the lightness pixel value is represented by a minimum value and the darkest value of the lightness pixel value is represented by a maximum value, the same process above may be followed, except that a smallest, rather than largest, pixel value of the three corresponding determined lightness values may be selected.

The above described methods and systems may identify and differentiate objects, shadows, and glares from each other irrespective of object shapes and colors, to robustly achieve superior shadow and glare reduction.

In the above described examples, three input images are captured and used to generate the output image. However it is not excluded that further, or a different number of, images be captured and used to refine the output image. In such cases, more than three light sources may be provided, and each input image may be captured while a different light source is lighted.

Thus, there have been described examples of imaging systems, computer readable storage media, and methods of image processing. In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

What is claimed is:

1. A method of image processing, the method comprising:
temporal median filtering three input images to generate a temporal median filtered image, each of the three input images representing a same scene and captured under different lighting conditions relative to each other;
identifying a shadow present in one or more of the three input images; and
removing the identified shadow from the temporal median filtered image to generate an output image.

2. The method of claim 1 further comprising successively capturing the three input images, each of the three input images being captured while a respective one of three light sources is lighted, the light sources being spaced apart from each other.

3. The method of claim 1 further comprising generating grayscale versions of the three input images, wherein temporal median filtering the three input images comprises temporal median filtering the grayscale versions of the three input images.

4. The method of claim 1 wherein the temporal median filtering comprises assigning, to each of a plurality of pixel values of the temporal median filtered image, a median pixel value of corresponding pixel values of the three input images.

5. The method of claim 1 wherein the identifying the shadow comprises:
generating a composite dark image by assigning, to each of a plurality of pixel values of the composite dark image, a darkest pixel value of corresponding pixel values of the three input images; and
generating a composite bright image by assigning, to each of a plurality of pixel values of the composite light dark image, a brightest pixel value of corresponding pixel values of the three input images.

6. The method of claim 5 wherein the identifying the shadow comprises:
generating a first difference image representing a difference between the temporal median filtered image and the composite dark image;
generating a second difference image representing a difference between the composite bright image and the composite dark image; and
region growing the first difference image onto the second difference image to generate a region grown difference image identifying the shadow.

7. The method of claim 6 wherein the identifying the shadow comprises generating a grayscale version of the temporal median filtered image, wherein generating the first difference image comprises generating the difference between the grayscale version of the temporal median filtered image and the composite dark image.

8. The method of claim 6 wherein the identifying the shadow comprises thresholding the first and second difference images each into a binary mask.

9. The method of claim 8 wherein the identifying the shadow comprises generating contours from the binary masks of the first and second difference images.

10. The method of claim 6 wherein the identifying the shadow comprises further comprising dilating the region grown difference image with a mask.

11. The method of claim 1 wherein the temporal median filtered image has reduced glare relative to the three input images.

12. A non-transitory computer readable storage medium including executable instructions that, when executed by a processor, cause the processor to:
generate, based on three input images representing a same scene and captured under different lighting conditions relative to each other, a temporal median filtered image having reduced glare relative to the three input images;
identifying a shadow present in one or more of the three input images; and
removing the identified shadow from the temporal median filtered image.

13. The non-transitory computer readable storage medium of claim 12 wherein the temporal median filtered image is generated by assigning, to each of a plurality of pixel values of the temporal median filtered image, a median pixel value of corresponding pixel values of the three input images.

14. An imaging system comprising:
three light sources spaced apart relative to each other;
an image capture device to capture three input images of a scene, each input image captured while a respective one of the three light sources is lighted; and
a processor to:
temporal median filter the three input images to generate a temporal median filtered image having reduced glare relative to the three input images; and
generate an output image by removing an identified shadow from the temporal median filtered image.

15. The imaging system of claim 14 wherein the temporal median filtered image is generated by assigning, to each of a plurality of pixel values of the temporal median filtered image, a median pixel value of corresponding pixel values of the three input images.
